(19) United States
(12) Patent Application Publication
(10) Pub. No.: US 2022/0221682 A1
(43) Pub. Date: Jul. 14, 2022

(54) LENS ASSEMBLY

(71) Applicant: SAMSUNG ELECTRO-MECHANICS CO., LTD., Suwon-si (KR)

(72) Inventors: So Mi YANG, Suwon-si (KR); Hak Young YOON, Suwon-si (KR); Jae Hyuk HUH, Suwon-si (KR); Yong Joo JO, Suwon-si (KR)

(73) Assignee: SAMSUNG ELECTRO-MECHANICS CO., LTD., Suwon-si (KR)

(21) Appl. No.: 17/314,319

(22) Filed: May 7, 2021

(30) Foreign Application Priority Data
Jan. 8, 2021 (KR) 10-2021-0002470

(51) Int. Cl. G02B 7/02; G03B 17/12; G02B 5/00

(52) U.S. Cl. CPC G02B 7/021; G02B 5/005; G03B 17/12

(57) ABSTRACT

A lens assembly includes: a lens barrel; lenses accommodated in the lens barrel; and a spacer disposed between neighboring lenses among the lenses, and having an incident hole. An inner side surface of the spacer surrounding the incident hole includes a first inner side surface and a second inner side surface facing each other, and a third inner side surface and a fourth inner side surface facing each other. Each of the first inner side surface, the second inner side surface, the third inner side surface, and the fourth inner side surface includes a concavely curved surface facing a center of the spacer. The first inner side surface, the second inner side surface, the third inner side surface, and the fourth inner side surface have radii of curvature R1, R2, R3, and R4, respectively. The lens assembly satisfies the expressions: R1=R2; R3≠R1; and R4≠R1.

### CROSS-REFERENCE TO RELATED APPLICATIONS

This application claims the benefit under 35 U.S.C. § 119(a) of Korean Patent Application No. 10-2021-0002470 filed on Jan. 8, 2021 in the Korean Intellectual Property Office, the entire disclosure of which is incorporated herein by reference for all purposes.

### BACKGROUND

### 1. Field

The present disclosure relates to a lens assembly, and more particularly, to a spacer disposed between neighboring lenses.

### 2. Description of Related Art

An image capturing device, which is a device for taking a picture or an image of a subject such as a person, an object, or a landscape, may acquire data from light incident on the image capturing device, and store the data as a file in a storage medium and/or display the image on a display unit.

The image capturing device may include a lens barrel including a plurality of lenses configured to capture an image of a subject. In order to maintain a space between lenses among the plurality of lenses, a lens spacer may be disposed between the lenses.

The lens spacer may vary in terms of material and formation method, depending on the space between the lenses. For example, when the space between the lenses is relatively large, a block-type lens spacer manufactured of a metal or a hard material through a machining process, such as a cutting process, may be used. On the other hand, when the space between the lenses is relatively small, a film-type lens spacer manufactured in a form of a thin film or plate through a pressing process may be used.

The spacer may be deformed depending on surrounding environments (e.g., temperature and humidity). When the spacer has an asymmetric shape (e.g., a D-cut shape), the spacer may be deformed to a greater degree according to the change in the surrounding environments. In this case, two lenses respectively disposed on opposite sides of the spacer may be minutely misaligned, resulting in a negative influence on image quality.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a lens assembly includes: a lens barrel; lenses accommodated in the lens barrel; and a spacer disposed between neighboring lenses among the lenses, and having an incident hole. An inner side surface of the spacer surrounding the incident hole includes a first inner side surface and a second inner side surface facing each other, and a third inner side surface and a fourth inner side surface facing each other. Each of the first inner side surface, the second inner side surface, the third inner side surface, and the fourth inner side surface includes a concavely curved surface facing a center of the spacer. The first inner side surface, the second inner side surface, the third inner side surface, and the fourth inner side surface have radii of curvature R1, R2, R3, and R4, respectively. The lens assembly satisfies the expressions: R1=R2; R3≠R1; and R4≠R1.

The lens assembly may satisfy the expressions: R1<R3; and R1<R4.

The lens assembly may satisfy the expressions: 0.12<R1/R3<0.50; and R3=R4.

The lens assembly may satisfy the following expressions: 0.12<R1/R3<0.50; 0.12<R1/R4<0.50; and R3≠R4.

The spacer may include a corrugated portion formed along the inner side surface. A distance between the corrugated portion and a center of curvature of the inner side surface may repeatedly increase and decrease locally along the inner side surface.

The corrugated portion may include a first corrugated portion formed on the first inner side surface. The lens assembly may satisfy the expressions: 50<R1/R5<400; and R1<R3, wherein R5 is a radius of a valley portion or a ridge portion in the first corrugated portion.

The corrugated portion may include a third corrugated portion formed on the third inner side surface. The lens assembly may satisfy the expressions: 10<R3/R7<70; and R1<R3, wherein R7 is a radius of a valley portion or a ridge portion in the third corrugated portion.

The corrugated portion may be formed along an entirety of the inner side surface.

The spacer may include a cutout portion connecting an outer side surface of the spacer to the inner side surface.

The spacer may include straight line portions facing each other and curved line portions facing each other. The cutout portion may be formed in one of the curved line portions.

The inner side surface and the outer side surface may each have a D-cut shape.

The inner side surface may have a circular shape. The outer side surface may have a D-cut shape.

The inner side surface and the outer side surface may each have a circular shape.

The lens cutout portion may have a width of 0.05 mm to 0.5 mm.

The spacer may have a thickness of 0.01 mm to 0.5 mm.

The spacer may have a thickness of 0.01 mm to 0.5 mm.

A width of the cutout portion at an upper surface of the spacer may be different from a width of the cutout portion at a lower surface of the spacer.

Other features and aspects will be apparent from the following detailed description, the drawings, and the claims.

### BRIEF DESCRIPTION OF DRAWINGS

FIG. 1 is a perspective view of a lens assembly, according to an embodiment.

FIG. 2 is a plan view of a spacer, according to an embodiment.

FIG. 3 is a plan view of a spacer, according to another embodiment.

FIG. 4 is a plan view of a spacer, according to another embodiment.

FIG. 5 is a plan view of a spacer, according to another embodiment.

FIG. 6 is a perspective view of a spacer, according to another embodiment.

FIG. 7 is a plan view of a spacer, according to another embodiment.

FIG. 8 is a plan view of a spacer, according to another embodiment.

FIG. 9 is a plan view of a spacer, according to another embodiment.

FIG. 10 is a plan view of a spacer, according to another embodiment.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure. Hereinafter, while embodiments of the present disclosure will be described in detail with reference to the accompanying drawings, it is noted that examples are not limited to the same.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. As used herein “portion” of an element may include the whole element or less than the whole element.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of this disclosure. Further, although the examples described herein have a variety of configurations, other configurations are possible as will be apparent after an understanding of this disclosure.

Herein, it is noted that use of the term “may” with respect to an example, for example, as to what an example may include or implement, means that at least one example exists in which such a feature is included or implemented while all examples are not limited thereto.

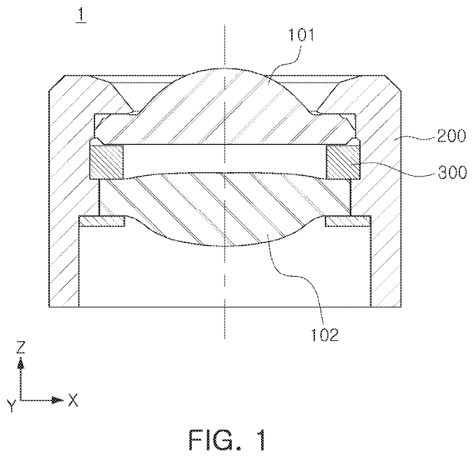

FIG. 1 is a perspective view of a lens assembly 1, according to an embodiment.

The lens assembly 1 may include lenses 101 and 102 and a lens barrel 200 accommodating the lenses 101 and 102 such that the lenses 101 and 102 are disposed adjacent to each other in an optical axis direction. In an example, the lens assembly 1 may include a spacer 300 disposed between the lenses 101 and 102. The spacer 300 may be configured to maintain a constant space between the two neighboring lenses 101 and 102. In designing an optical system, the space between the lenses 101 and 102 acts as a major factor affecting image quality. Through the spacer 300, the lenses 101 and 102 may be spaced apart from each other on opposite sides of the spacer 300 to have a predetermined space therebetween.

In an example, the spacer 300 may include an incident hole inside the spacer 300, and light may pass through the incident hole between the first lens 101 and the second lens 102.

In addition, the spacer 300 may be configured to partially block the light having passed through one lens 101. For example, the spacer 300 may partially block the light having passed through a periphery of the first lens 101. By partially blocking the light, the spacer 300 may prevent or minimize a flare phenomenon.

In an example, the spacer 300 may be manufactured of a plastic or metal material. For example, the spacer 300 may be manufactured of a polyethylene terephthalate (PET) or metal material having a thickness of about 0.01 mm to 0.1 mm. In another example, the spacer 300 may be manufactured of a plastic material having a thickness of about 0.1 mm to 0.5 mm.

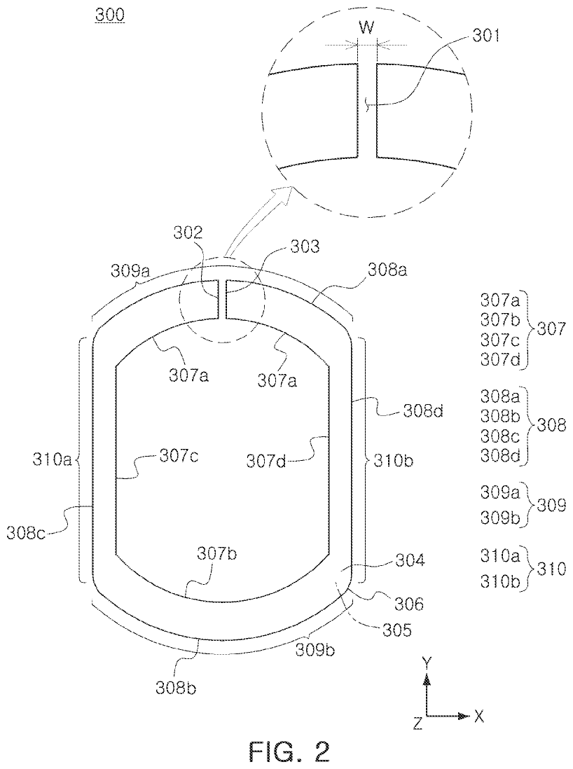

Hereinafter, various spacers provided between the lenses 101 and 102 will be described with reference to FIGS. 2 through 10. Each of the spacers to be described below may be applied to any optical system in which the two neighboring lenses 101 and 102 are included, and is not limited to that applied to the lens assembly 1 illustrated in FIG. 1.

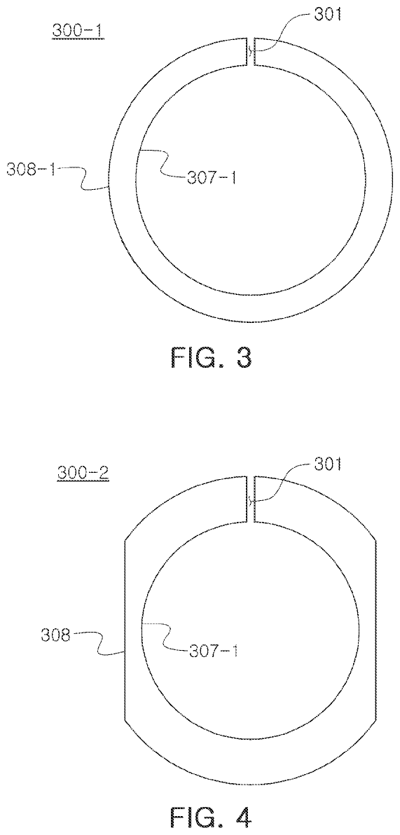

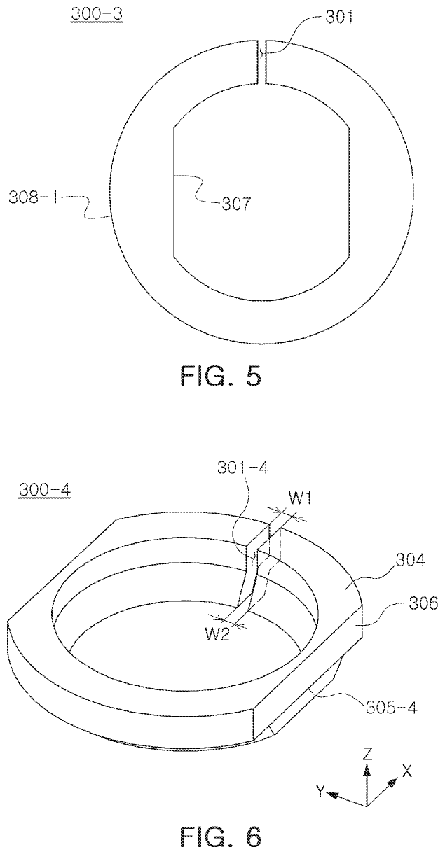

FIG. 2 is a plan view of the spacer 300, according to an embodiment. FIG. 3 is a plan view of a spacer 300-1, according to another embodiment. FIG. 4 is a plan view of a spacer 300-2, according to another embodiment. FIG. 5 is a plan view of a spacer 300-3, according to another embodiment. FIG. 6 is a perspective view of a spacer 300-4, according to another embodiment.

Referring to FIG. 2, the spacer 300 may have a ring shape extending along edge portions of lenses (e.g., the lenses 101 and 102 in FIG. 1). The spacer 300 may include a cutout portion 301. For example, the spacer 300 may have a “C” shape. Two ends 302 and 303 of the spacer 300 may face each other with the cutout portion 301 interposed therebetween. A space between both ends 302 and 303 of the spacer 300 (that is, a width W of the cutout portion 301) may be formed to be relatively narrow, so that no negative influence is caused in maintaining the space between the lenses 101 and 102, which are disposed on an upper surface 304 and a lower surface 305 of the spacer 300, respectively. For example, the width W of the cutout portion 301 of the spacer 300 may have a smaller value than an overall width of the spacer 300.

In an example, the spacer 300 may be manufactured of a polyethylene terephthalate (PET) or metal material having a thickness of about 0.01 mm to 0.1 mm. In this case, the width W of the cutout portion 301 may have a value between about 0.05 mm and about 0.5 mm. In another example, the spacer 300 may be manufactured of a plastic material having a thickness between about 0.1 mm and about 0.5 mm. In this case, the width W of the cutout portion 301 may have a value between about 0.1 mm and about 0.5 mm.

In an embodiment, the spacer 300 may include the upper surface 304, the lower surface 305, and a side surface 306 extending from the upper surface 304 to the lower surface 305. The side surface 306 may include an inner side surface 307 facing the center of the spacer 300 and an outer side surface 308 facing outside the spacer 300. The inner side surface 307 of the spacer 300 may at least partially surround the incident hole inside the spacer 300.

Referring to FIG. 2, the inner side surface 307 and the outer side surface 308 may be connected to each other through the cutout portion 301. For example, the inner side surface 307 and the outer side surface 308 may be connected to each other through the cutout portion 301 such that a single closed curve is formed.

The spacer 300 may be deformed depending on surrounding environmental conditions (e.g., temperature and humidity). When the spacer 300 has an asymmetric shape, the spacer 300 may be deformed to a greater degree according to the change in the surrounding environmental conditions. In this case, the two lenses 101 and 102 disposed on both sides of the spacer 300 may be minutely misaligned, resulting in a negative influence on image quality.

As described above, the spacer 300 may include the cutout portion 301, which may minimize a degree of deformation of the spacer 300. The cutout portion 301 may minimize or prevent misalignment between the lenses 101 and 102 on both sides of the spacer 300, and improve the performance of the optical system including the spacer 300.

In an example, the spacer 300 may have a D-cut shape. For example, the spacer 300 may include two straight line portions 310 facing each other in parallel and two curved line portions 309 facing each other. Each of the curved line portions 309 may have an arc shape. For example, the curved line portions 309 may have a shape of a pair of parentheses (i.e., “( )”). Each of the straight line portions 310 may be a portion extending in a straight line shape or in an approximately straight line shape.

Referring to FIG. 2, in an example, both the inner side surface 307 and the outer side surface 308 of the spacer 300 may have a D-cut shape. A first inner side surface 307a and a first outer side surface 308a may define one curved line portion 309a of the D-cut shape, and a second inner side surface 307b and a second outer side surface 308b may define the other curved line portion 309b of the D-cut shape. Also, a third inner side surface 307c and a third outer side surface 308c may define one straight line portion 310a of the D-cut shape, and a fourth inner side surface 307d and a fourth outer side surface 308d may define the other straight line portion 310b of the D-cut shape.

In an example, at least one of the inner side surface 307 and the outer side surface 308 of the spacer 300 may have a D-cut shape.

Referring to FIG. 3, a spacer 300-1, according to an embodiment, may include an inner side surface 307-1 and an outer side surface 308-1 both having a circular shape. Referring to FIG. 4, a spacer 300-2, according to an embodiment, may include an inner side surface 307-1 having a circular shape and the outer side surface 308 having a D-cut shape. Referring to FIG. 5, a spacer 300-3, according to an embodiment, may include the inner side surface 307 having a D-cut shape and the outer side surface 308-1 having a circular shape.

In an example, the cutout portion 301 may be formed in one of the curved line portions (e.g., the curved line portion 309 in FIG. 1, and the curved-line portions in FIGS. 2 to 5). That is, referring to FIG. 2, the cutout portion 301 may be provided by cutting out the curved line portion 309a or 309b of the D-cut shape. For example, referring to FIG. 2, the first inner side surface 307a and the first outer side surface 308a may define one curved line portion 309a of the D-cut shape, and the cutout portion 301 may connect a center portion of the first inner side surface 307a and a center portion of the first outer side surface 308a to each other.

However, the position of the cutout portion 301 is not limited to that in the embodiments illustrated in FIGS. 2 through 5. For example, the cutout portion 301 illustrated in FIG. 2 may be formed by cutting out a portion surrounded by the third inner side surface 307c and the third outer side surface 308c.

In an example, the width of the cutout portion 301 may be determined so that both ends 302 and 303 of the cutout portion 301 do not contact each other even when the spacer 300 is thermally expanded. For example, the width of the cutout portion 301 may be in the range of 0.05 mm to 0.5 mm.

Referring to FIG. 6, in an embodiment, a cutout portion 301-4 of a spacer 300-4 may vary in a thickness direction. For example, referring to FIG. 6, the upper surface 304 and a lower surface 305-4 of the spacer 300-4 may have different shapes, and the width W1 of the cutout portion 301-4 at the upper surface 304 may be different than a width W2 of the cutout portion 301-4 at the lower surface 305 (W1≠W2). For example, a width of the cutout portion 301-4 may progressively change from the width W1 to the width W2 between the upper surface 304 and the lower surface 305.

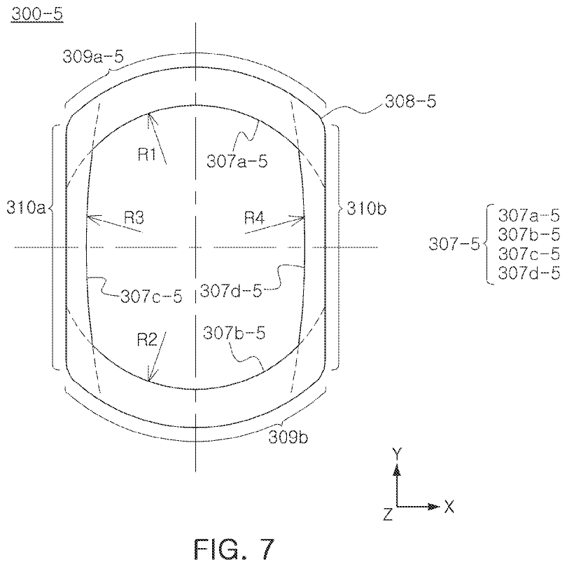

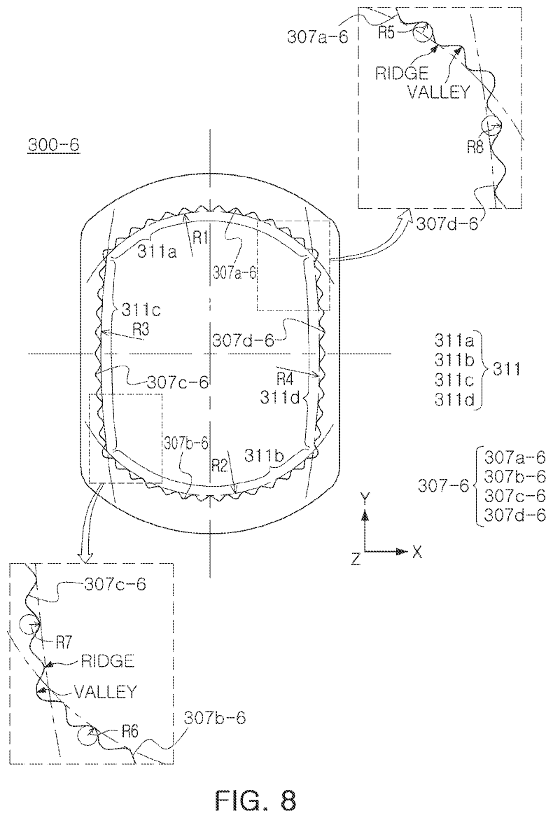

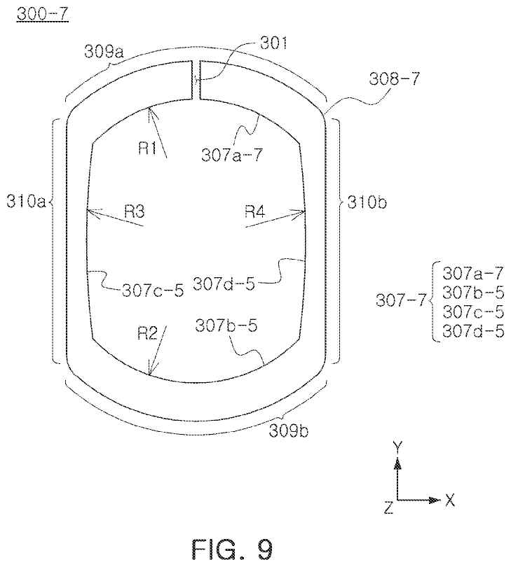

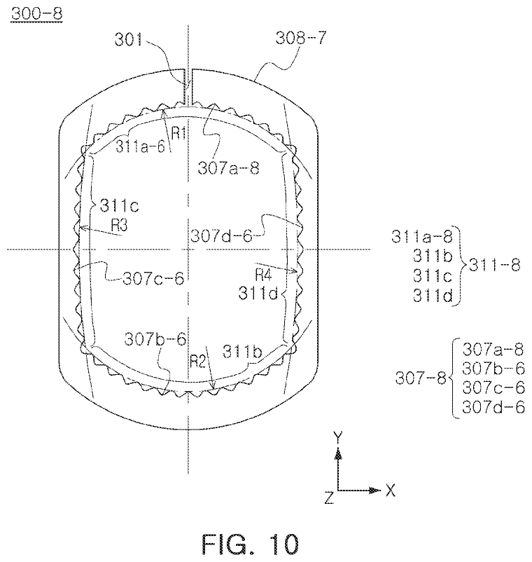

FIG. 7 is a plan view of a spacer 300-5, according to another embodiment. FIG. 8 is a plan view of a spacer 300-6, according to another embodiment. FIG. 9 is a plan view of a spacer 300-7, according to another embodiment. FIG. 10 is a plan view of a spacer 300-8, according to another embodiment.

Referring to FIG. 7, in an embodiment, an inner side surface 307-5 of the spacer 300-5 may be formed as an entirely curved surface. For example, each of a first inner side surface 307a-5, a second inner side surface 307b-5, a third inner side surface 307c-5, and a fourth inner side surface 307d-5 may have an arc shape. For example, the first inner side surface 307a-5, the second inner side surface 307b-5, the third inner side surface 307c-5, and the fourth inner side surface 307d-5 may have a first radius R1, a second radius R2, a third radius R3, and a fourth radius R4, respectively.

In an example, the inner side surface 307-5 may have a concave shape when viewed from the center of the spacer 300-5. In an example, the center of curvature of the inner side surface 307-5 of the spacer 300-5 may be located in a direction that the inner side surface 307-5 faces. For example, the center of curvature of the first inner side surface 307a-5 may be located in direction −Y with respect to the first inner side surface 307a-5. The center of curvature of the second inner side surface 307b-5 may be located in direction +Y with respect to the second inner side surface 307b-5. The center of curvature of the third inner side surface 307c-5 may be located in direction +X with respect to the third inner side surface 307c-5. The center of curvature of the fourth inner side surface 307d-5 may be located in direction −X with respect to the fourth inner side surface 307d-5.

In an example, the radii of curvature (hereinafter, referred to as “radii”) of the inner side surfaces 307a-5, 307b-5, 307c-5, and 307d-5 may be the same or different. In an example, the inner side surfaces 307a-5 and 307b-5 or 307c-5 and 307d-5 facing each other may have the same radius. For example, the first radius R1 may be the same as the second radius R2, and the third radius R3 may be the same as the fourth radius R4. In another example, the inner side surfaces facing each other may have different radii. For example, the first radius R1 may be the same as the second radius R2, but the third radius R3 may be different from the fourth radius R4.

In an example, the spacer 300-5 may have a D-cut shape. In The outer side surface 308-5 of the spacer 300 may include the two straight line portions 310a and 310b facing each other in parallel and two curved line portions 309a-5 and 309b facing each other. In an example, the radius of the inner side surface (e.g., the third inner side surface 307c-5 or the fourth inner side surface 307d-5) corresponding to the straight line portion 310a or 310b may be greater than that of the inner side surface (e.g., the first inner side surface 307a-5 or the second inner side surface 307b-5) corresponding to the curved line portion 309a or 309b. For example, the first inner side surface 307a and the second inner side surface 307b may correspond to the curved line portions 309a-5 and 309b of the D-cut shape and have the first radius R1 and the second radius R2, respectively. Also, the third inner side surface 307c-5 and the fourth inner side surface 307d-5 may correspond to the straight line portions 310a and 310b of the D-cut shape and have the third radius R3 and the fourth radius R4, respectively. In this case, the third radius R3 and the fourth radius R4 may be greater than the first radius R1 or the second radius R2. That is, the third inner side surface 307-5c and the fourth inner side surface 307d-5 may have curved surfaces flatter than those of the first inner side surface 307a-5 or the second inner side surface 307b-5. In this case, the following Conditional Expression (1) may be satisfied between the first inner side surface 307a-5 (or the second inner side surface 307b) and the third inner side surface 307c-5 (or the fourth inner side surface 307d-5) neighboring to each other.

0.12<R1(or R2)/R3(or R4)<0.50 Conditional Expression (1)

The spacer 300-5 may include the concave inner side surface 307-5 to prevent or minimize a flare phenomenon caused by light reflected from the inner side surface 307-5 of the spacer 300-5. In addition, an optical system including the spacer 300-5 with the concave inner side surface 307-5 may have a sufficient opening area to achieve a higher f-number (fno), as compared with that when an inner side surface of a spacer is flat or convex.

Referring to FIG. 8, in an embodiment, the spacer 300-6 may include a corrugated portion 311 at least partially formed on an inner side surface 307-6. In the illustrated embodiment, inner side surfaces 307a-6, 307b-6, 307c-6, and 307d-6 may include corrugated portions 311a, 311b, 311c and 311d, respectively.

In the embodiment of FIG. 7, a distance between the first inner side surface 307a-5 and the center of curvature of the first inner side surface 307a-5 is constant as the first radius R1. In contrast, referring to FIG. 8, when measuring a distance between the first inner side surface 307a-6 and the center of curvature thereof in a circumferential direction, the distance may repeatedly increase and decrease within a predetermined range based on the first radius R1 because of the first corrugated portion 311a. In an example, a distance between the corrugated portion 311 and the center of curvature of the inner side surface 307-6 on which the corrugated portion 311 is located may repeatedly increase and decrease locally along the inner side surface 307-6. In an example, the corrugated portion 311 may be defined by alternately arranging a plurality of valleys and a plurality of ridges. In this case, the distance between the inner side surface 307-6 and the center of curvature thereof may be greatest at the valleys and smallest at the ridges.

In the embodiment illustrated in FIG. 8, the corrugated portion 311 is present entirely on the inner side surface 307-6 of the spacer 300-6. However, in another embodiment, the corrugated portion 311 may be included only partially on the inner side surface 307-6. For example, the third inner side surface 307c-6 and the fourth inner side surface 307d-6 may include a third corrugated portion 311c and a fourth corrugated portion 311d, respectively, and the corrugated portions 311a and 311b may be omitted on the first inner side surface 307a-6 and the second inner side surface 307b-6.

In an embodiment, the corrugated portion 311 may have an arc shape. Referring to FIG. 8, valley portions (or ridge portions) of the corrugated portions 311a and 311b constituting the first inner side surface 307a-6 and the second inner side surface 307b-6 may have a fifth radius R5 and a sixth radius R6, respectively. Also, valley portions (or ridge portions) of the corrugated portions 311c and 311d constituting the third inner side surface 307c-6 and the fourth inner side surface 307d-6 may have a seventh radius R7 and an eighth radius R8, respectively.

In an embodiment, the corrugated portions 311a and 311b or 311c and 311d formed on the inner side surfaces 307a-6 and 307b-6 or 307c-6 and 307d-6 facing each other may have the same radius. For example, the fifth radius R5 and the sixth radius R6 may conform to each other, and the seventh radius R7 and the eighth radius R8 may conform to each other.

In an embodiment, each of the valley portions and the ridge portions of the corrugated portion 311 may have a radius smaller than the radius of the inner side surface 307-6 on which the corrugated portion 311 is located. In an embodiment, the inner side surfaces 307a-6, 307b-6, 307c-6, and 307d-6 may be configured to satisfy the following Conditional Expression (2) and/or the following Conditional Expression (3). For example, the first radius R1 (or the second radius R2) and the fifth radius R5 (or the sixth radius R6) may satisfy the following Conditional Expression (2), and the third radius R3 (or the fourth radius R4) and the seventh radius R7 (or the eighth radius R8) may satisfy the following Conditional Expression (3).

50<R1(or R2)/R5(or R6)<400, where R1<R3 Conditional Expression (2)

10<R3(or R4)/R7(or R8)<70, where R1<R3 Conditional Expression (3)

Referring to FIGS. 9 and 10, the spacers 300-7 and 300-8, which are similar to the spacers 300-5 and 300-6, respectively, illustrated in FIG. 7 and FIG. 8, may further include a cutout portion 301. The cutout portion 301 of FIGS. 9 and 10 may be configured to be identical or similar to those described in FIGS. 2 through 6.

Referring to FIG. 9, in an embodiment, all of a first inner side surface 307a-5 to the fourth inner side surface 307d-5 constituting an inner side surface 307-7of the spacer 300 may have concavely curved surfaces when viewed from the center of the spacer 300-7, and a portion of a first inner side surface 307a-5 may be connected to an outer side surface 308-7 through the cutout portion 301.

Referring to FIG. 10, in an embodiment, all of a first inner side surface 307a-8 to the fourth inner side surface 307d-6 constituting an inner side surface 307-8 of the spacer 300-8 may have concavely curved surfaces when viewed from the center of the spacer 300-8, the inner side surface 307-8 may at least partially include a corrugated portion 311-8, and a portion of the first inner side surface 307a-8 may be connected to the outer side surface 308-7 through the cutout portion 301.

The corrugated portion 311-8 included in the spacer 300-8 may prevent or minimize a flare phenomenon caused by light reflected from the inner side surface 307-8 of the spacer 300-8.

Embodiments of the disclosure herein are not limited to those illustrated in FIGS. 2 through 10. Although not explicitly described in this disclosure, an embodiment including some or all of the features of the spacers 300 to 300-8 described herein may also fall within the scope of the disclosure. For example, if the embodiment of FIG. 4 and the embodiment of FIG. 8, in which the circular inner side surface 307-1 and the corrugated portion 311 are included as their features respectively, are combined together, the spacer may include a circular inner side surface and a corrugated portion provided on the inner side surface.

As set forth above, according to embodiments disclosed herein, a spacer and a lens assembly including the spacer may be capable of stably maintaining a space between neighboring lenses and preventing a deterioration in image quality.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens assembly, comprising:
a lens barrel;
lenses accommodated in the lens barrel; and
a spacer disposed between neighboring lenses among the lenses, and having an incident hole,
wherein an inner side surface of the spacer surrounding the incident hole includes a first inner side surface and a second inner side surface facing each other, and a third inner side surface and a fourth inner side surface facing each other,
wherein each of the first inner side surface, the second inner side surface, the third inner side surface, and the fourth inner side surface includes a concavely curved surface, facing a center of the spacer,
wherein the first inner side surface, the second inner side surface, the third inner side surface, and the fourth inner side surface have radii of curvature R1, R2, R3, and R4, respectively, and
wherein the lens assembly satisfies the expressions:
R1=R2;
R3≠R1; and
R4≠R1.

2. The lens assembly of claim 1, wherein the lens assembly satisfies the expressions:
R1<R3; and
R1<R4.

3. The lens assembly of claim 1, wherein the lens assembly satisfies the expressions:
0.12<R1/R3<0.50; and
R3=R4.

4. The lens assembly of claim 1, wherein the lens assembly satisfies the following expressions:
0.12<R1/R3<0.50;
0.12<R1/R4<0.50; and
R3≠R4.

5. The lens assembly of claim 1, wherein the spacer includes a corrugated portion formed along the inner side surface, and
wherein a distance between the corrugated portion and a center of curvature of the inner side surface repeatedly increases and decreases locally along the inner side surface.

6. The lens assembly of claim 5, wherein the corrugated portion includes a first corrugated portion formed on the first inner side surface,
wherein the lens assembly satisfies the expressions:
50<R1/R5<400; and
R1<R3, and
wherein R5 is a radius of a valley portion or a ridge portion in the first corrugated portion.

7. The lens assembly of claim 5, wherein the corrugated portion includes a third corrugated portion formed on the third inner side surface,
wherein the lens assembly satisfies the expressions:
10<R3/R7<70; and
R1<R3, and
wherein R7 is a radius of a valley portion or a ridge portion in the third corrugated portion.

8. The lens assembly of claim 1, wherein the corrugated portion is formed along an entirety of the inner side surface.

9. The lens assembly of claim 1, wherein the spacer includes a cutout portion connecting an outer side surface of the spacer to the inner side surface.

10. The lens assembly of claim 9, wherein the spacer includes straight line portions facing each other and curved line portions facing each other, and the cutout portion is formed in one of the curved line portions.

11. The lens assembly of claim 9, wherein the inner side surface and the outer side surface each have a D-cut shape.

12. The lens assembly of claim 9, wherein the inner side surface has a circular shape, and the outer side surface has a D-cut shape.

13. The lens assembly of claim 9, wherein the inner side surface and the outer side surface each have a circular shape.

14. The lens assembly of claim 9, wherein the cutout portion has a width of 0.05 mm to 0.5 mm.

15. The lens assembly of claim 14, wherein the spacer has a thickness of 0.01 mm to 0.5 mm.

16. The lens assembly of claim 9, wherein the spacer has a thickness of 0.01 mm to 0.5 mm.

17. The lens assembly of claim 9, wherein a width of the cutout portion at an upper surface of the spacer is different from a width of the cutout portion at a lower surface of the spacer.
